(19) United States
(12) Patent Application Publication
(10) Pub. No.: US 2005/0161157 A1
(43) Pub. Date: Jul. 28, 2005

(54) Substrate treating apparatus and method

(75) Inventors: Shigetsugu Muramatsu, Nagano-shi (JP); Masahiro Kyozuka, Nagano-shi (JP); Motoyuki Komatsu, Nagano-shi (JP)

Correspondence Address: RANKIN, HILL, PORTER & CLARK LLP, 4080 ERIE STREET, WILLOUGHBY, OH, 44094-7836, US

(73) Assignee: SHINKO ELECTRIC INDUSTRIES CO., LTD., Nagano-shi (JP)

(21) Appl. No.: 11/042,737

(22) Filed: Jan. 25, 2005

(30) Foreign Application Priority Data
Jan. 27, 2004 (JP) 2004-018560

(51) Int. Cl. C23F 1/00; B05D 3/12; B05D 5/00

(52) U.S. Cl. 156/345.21; 427/356; 427/211; 156/345.2

(57) ABSTRACT

A substrate treating apparatus feeds a treating solution to a substrate while transferring the substrate, and treats the surfaces of the substrate. The substrate treating apparatus includes feed rollers, treating drums, and spray units. The feed rollers transfer the substrate. The treating drums treat the surfaces of the substrate. The spray units feed the treating solution to the substrate. The feed rollers are disposed so as to transfer the substrate with the substrate plane of the substrate being vertically oriented. The treating drums are respectively disposed on the opposite surface sides of the substrate with each outer circumferential surface being in sliding contact with the surface of the substrate. The spray units are disposed on the opposite sides of the direction of transfer of the substrate.

This application claims foreign priority based on Japanese patent application JP 2004-018560, filed on Jan. 27, 2004, the contents of which is incorporated herein by reference in its entirety.

### BACKGROUND OF THE INVENTION

1. Field of the Invention

The present invention relates to a substrate treating apparatus and method. More particularly, it relates to a substrate treating apparatus for performing etching, washing, polishing, and the like on the surface of a substrate such as a wiring substrate.

2. Description of the Related Art

The manufacturing steps of a semiconductor device include a treating step of etching, washing, or polishing the surface of a wiring substrate such as a printed circuit substrate. As a method for treating a substrate through this treating step, there is a method for treating a substrate 10 while continuously transferring it by a transfer conveyor as shown in FIG. 6 (For example, see JP-A-9-174429). In FIG. 6, a reference numeral 12 denotes a treating drum; 14, a feed roller for transferring the substrate 10; and 16, a presser roller for pressing the substrate 10 between it and the treating drum 12. The treating drum 12 has an outer surface formed of a pad or a polishing grindstone, and feeds an etchant, a washing solution, and a polishing solution to the substrate 10 while transferring the substrate 10. Thus, a prescribed treatment is carried out by the treating drum 12.

FIG. 6 shows an apparatus for treating the opposite sides of the substrate 10 in one step while transferring the substrate 10 which is an article to be processed by a transfer conveyor. The apparatus is configured as follows. The treating drums 12 are respectively disposed on the top side and the bottom side interposing the substrate 10. Spray units 18a and 18b of a treating solution are respectively disposed above and under the transfer conveyor, so that the opposite sides of the substrate 10 are sprayed with the treating solution, and treated.

Thus, for treating the opposite sides of the substrate 10, when the substrate 10 is horizontally transferred, and the opposite sides of the substrate 10 are fed with the treating solution, and treated, the amount (retained amount) of the treating solution fed to the substrate 10 becomes unequal between the top side and the bottom side of the substrate 10 under the influence of the gravity. This unfavorably results indifferent treating conditions for the opposite sides of the substrate 10. In particular, when the treating solution is the solution for chemically etching and treating the surface of the substrate 10, the variations in the treated conditions between the opposite sides of the substrate 10 increase according to the amounts of the treating solution on the opposite sides of the substrate 10. Accordingly, the treating conditions for the opposite sides of the substrate 10 vary. This unfavorably makes it impossible for the opposite sides of the substrate 10 to be equally finished. In such a case, each side of the substrate 10 may be treated in one step in order to equally finish the opposite sides of the substrate 10. However, in such a case, the productivity is unfavorably reduced.

### SUMMARY OF THE INVENTION

The invention has been completed in order to solve the problems. It is therefore an object of the present invention to provide a substrate treating apparatus and method capable of equally feeding a treating solution to the opposite sides of a substrate, and thereby capable of treating the opposite sides of the substrate under the uniform conditions.

The invention includes the following constitutions for achieving the foregoing object.

Namely, a substrate treating apparatus for feeding a treating solution to a substrate while transferring the substrate, and treating surfaces of the substrate with the treating solution, comprises: a transfer unit for transferring the substrate; treating drums respectively disposed on opposite surface sides of the substrate with each outer circumferential surface being in sliding contact with a surface of the substrate; and feed units respectively disposed on opposite sides of a direction of transfer of the substrate, for feeding the treating solution to the substrate, wherein the transfer unit is disposed so as to transfer the substrate with a substrate plane being vertically oriented.

In the substrate treating apparatus, the transfer unit may be disposed so as to set the direction of transfer of the substrate along a direction obliquely tilted with respect to a vertical direction, the treating drums may be disposed at positions such that a direction of each axis is orthogonal to the direction of transfer of the substrate, and the feed units may be disposed such that the treating solution is fed from an upper part side of each treating drum toward the substrate, and such that the treating solution flows toward a lower part side of each treating drum along the treating drum.

Alternately, the transfer unit may be disposed such that the direction of transfer of the substrate is along a vertical direction, the treating drums maybe disposed with a direction of each axis being horizontally positioned, and the feed units may be spray units for injecting the treating solution in a spray toward the substrate.

Further, the substrate treating apparatus may comprises: at least one damplated is posed on an end face side of the substrate and the treating drum, for preventing the treating solution from flowing out from an end face side of a retention region, the retention region being a region formed between the substrate and each treating drum for retaining the treating solution. Furthermore, in the substrate treating apparatus, the transfer unit may be disposed such that the direction of transfer of the substrate is along a vertical direction, the treating drums may be disposed with a direction of each axis being horizontally positioned, and the feed units may be feed nozzles each for feeding the treating solution to a retention region in an injecting manner, the retention region being a region formed between the substrate and each treating drum for retaining the treating solution.

With a substrate treating apparatus in accordance with the present invention, a substrate is transferred with the substrate plane being along the vertical direction, and feed units for feeding a treating solution toward the substrate are disposed on the opposite sides of the substrate. As a result, it is possible to avoid that the amounts of the treating solution to be fed to the opposite sides of the substrate become unequal by the action of the gravity. This enables the opposite sides of the substrate to be equally treated, which enables the substrate to be treated with precision and with efficiency.

### BRIEF DESCRIPTION OF THE DRAWINGS

FIG. 1 is a diagram showing an exemplary, non-limiting configuration of a first embodiment of a substrate treating apparatus;

FIG. 2 is a diagram showing an exemplary, non-limiting another example of the configuration of the substrate treating apparatus;

FIG. 3 is a diagram showing an exemplary, non-limiting configuration of a second embodiment of the substrate treating apparatus;

FIGS. 4A and 4B are diagrams respectively showing the state, as seen from the direction of the side of a substrate, of the substrate, treating drums, and damplates, and the manner in which a treating solution is retained;

FIG. 5 is a diagram showing an exemplary, non-limiting configuration of a third embodiment of the substrate treating apparatus; and

FIG. 6 is an explanatory diagram showing a related-art configuration of the substrate treating apparatus.

### DETAILED DESCRIPTION OF THE INVENTION

Hereinafter, exemplary, non-limiting embodiments of the invention will be explained with reference to the accompanying drawings. In the present invention, terms are presumed to have their ordinary meaning as would be understood by one of ordinary skill in the relevant art.

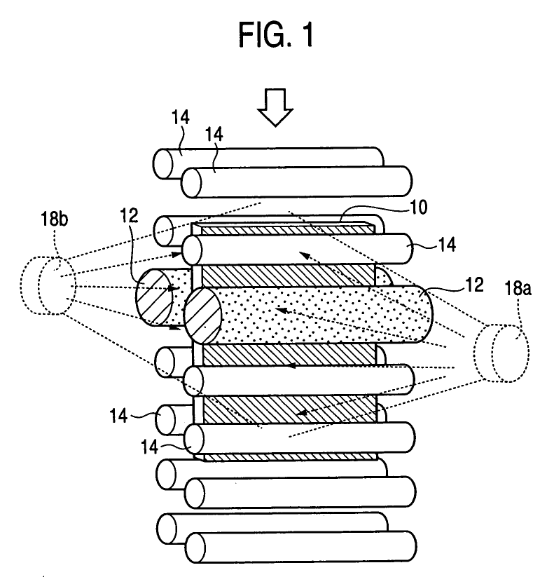

FIG. 1 is a diagram showing an exemplary, non-limiting configuration of a first embodiment of a substrate treating apparatus in accordance with the invention. The treating apparatus of the embodiment is characterized by being configured as follows. The substrate plane of a substrate 10 which is an article to be processed is set along the vertical direction, and the direction of transfer of the substrate 10 is set along the vertical direction. Thus, the opposite sides of the substrate 10 are surface treated.

In order to set the substrate plane of the substrate 10 along the vertical direction, feed rollers 14 are disposed so as to interpose the substrate 10 along the direction of thickness between the feed rollers 14, and so that the substrate plane of the substrate 10 is vertically oriented. The direction of each axis of the feed rollers 14 is set along the horizontal direction in order to set the direction of transfer of the substrate 10 along the vertical direction. The feed rollers 14 are rotatably driven in one direction by a driving motor (not shown), whereby the substrate 10 is transferred. Incidentally, the substrate 10 is generally transferred vertically downward from the upper level. However, it is also possible to transfer the substrate 10 vertically upward from the lower level for treatment.

When the substrate 10 is transferred vertically, the opposite sides of the substrate 10 are treated. For this reason, the treating drums 12 are disposed on the opposite sides sandwiching the substrate 10. The treating drums 12 are for etching, washing, or polishing the surfaces of the substrate 10, and each have the same configuration as that of the treating drum 12 used in a related-art treating apparatus. In order to treat the surfaces of the substrate 10, the treating drums 12 are disposed so that the outer circumferential surface of each treating drum 12 comes in contact with the surface of the substrate 10 when the substrate 10 passes through between the treating drums 12. In general, the treating drums 12 are rotatably driven by a motor independently of the feed rollers 14.

For feeding a treating solution toward the substrate 10 being transferred by the feed rollers 14, spray units 18a and 18b are disposed as feeding units of the treating solution so as to sandwich the treating drums 12 and the feed rollers 14 respectively disposed side by side on the opposite sides of the direction of transfer of the substrate 10. These spray units 18a and 18b are respectively for spraying and feeding the treating solution onto the opposites sides of the substrate 10. The treating solution is injected equally on to the opposite sides of the substrate 10 from the spray units 18a and 18b, and the treating drums 12 are rotatably driven. As a result, the surfaces of the substrate 10 are subjected to an etching, washing, or polishing treatment. Incidentally, a part of the treating solution injected from the spray units 18a and 18b is retained in a region interposed between the substrate 10 and the outer circumferential surface of the treating drum 12, and performs a treating action on the substrate 10.

With the substrate treating apparatus of this embodiment, as described above, the opposite sides of the substrate 10 are fed with a treating solution from the spray units 18a and 18b while vertically transferring the substrate 10, so that a treatment is performed. Therefore, the amounts of the treating solution to be fed and to be retained on the opposite sides of the substrate 10 will not be unbalanced by the action of the gravity. Therefore, the effects of treating the substrate 10 by the treating solution become entirely equal to each other for the opposite sides of the substrate 10. Namely, the substrate 10 is treated equally for the opposite sides. This enables the prevention of variations in the treating effects on the opposite sides of the substrate 10.

As described above, as for the amount of the treating solution acting on the substrate 10, the amount of the treating solution to be retained on the substrate 10 affects the treating action when the treating solution predominantly exerts a chemical etching effect. However, for the treating apparatus of this embodiment, the amounts of the treating solution to be retained on the opposite sides of the substrate 10 become equal. Therefore, it is possible to mutually match the treating conditions for the opposite sides of the substrate 10. This enables the treatment of the opposite sides of the substrate 10 to be carried out with ease and with reliability.

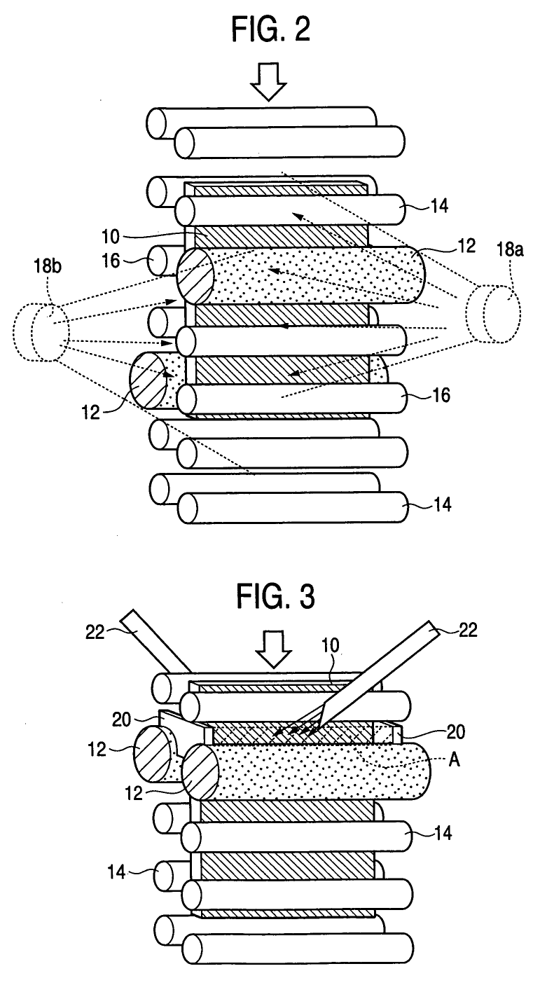

FIG. 1 is an example in which the treating drums 12 are disposed at positions mutually opposing across the substrate 10 therebetween. FIG. 2 is an example in which the treating drums 12 are disposed at different positions between the one side and the other side of the substrate 10. A reference number 16 denotes presser rollers disposed in opposing relation to the treating drums 12. Thus, the treating drums 12 can be disposed at appropriate positions relative to the direction of transfer of the substrate 10.

FIG. 3 is a diagram showing an exemplary, non-limiting configuration of a second embodiment of the substrate treating apparatus. The substrate treating apparatus of this embodiment is characterized in that the treating solution is positively retained between the treating drums 12 and the substrate 10 for treatment. It is characterized in that dam plates 20 for preventing the flow out of the treating solution from the lateral edge sides of the substrate 10 and the treating drums 12 are disposed. In this embodiment, the dam plates 20 are disposed so that the inner sides thereof come in sliding contact with the lateral sides of the substrate 10 being transferred by the feed rollers 14. In addition, the dam plates 20 are disposed so that the lower sides of the dam plates 20 come in sliding contact with the inner side portions of the treating drums 12. By disposing the dam plates 20 in this manner, it is possible to treat the substrate 10 without flow out of the treating solution from the end face sides of the substrate 10 and the treating drums 12 when the treating drums 12 are rotatably driven while transferring the substrate 10. The dame plates 20 are desirably formed of a soft material such as rubber in order not to damage the substrate 10 and the treating drums 12 when they come in sliding contact with the substrate 10 and the treating drums 12.

As shown in FIG. 3, the dame plates 20 are disposed so as to be in sliding contact with the substrate 10 and the treating drums 12. As a result, the region surrounded by the substrate 10, each treating drum 12, and each dam plate 20 serves as a retention part for retaining the treating solution therein. The top of the retention part is opened. Therefore, by feeding the treating solution by each feed nozzle 22 from above the retention part, it is possible to retain the treating solution in the retention part for treating the substrate 10.

Also in this embodiment, it is possible to inject the treating solution in a spray toward the substrate 10 as with the embodiments shown in FIGS. 1 and 2, and to directly feed the treating solution to the substrate 10 while retaining the treating solution in the retention part for treatment. By feeding the treating solution to the retention part from the feed nozzles 22, it becomes possible to use the treating solution with efficiency.

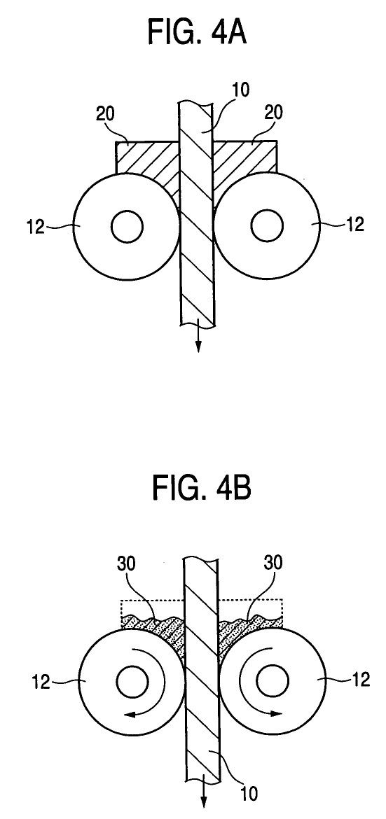

FIG. 4A shows the state of the layout of the substrate 10, the treating drums 12, and the dam plates 20 as seen from the side of the substrate 10. Incidentally, FIG. 3 shows the example in which the retention part is formed by allowing the inner side of each dam plate 20 to be in sliding contact with the side of the substrate 10. Whereas, FIGS. 4A and 4B show the example in which the retention part is formed by allowing one side of each dam plate 20 to be in sliding contact with the treated surface in the vicinity of the side edge of the substrate 10, and allowing the bottom of each dam plate 20 to be in sliding contact with the inner portion of each treating drum 12. FIG. 4B shows the state in which the treating drums 12 are being rotatably driven with a treating solution 30 retained in the retention part surrounded by the substrate 10, each treating drum 12, and each dam plate 20.

Incidentally, FIG. 4B shows the state in which the treating drums 12 are being rotatably driven in the same direction as the direction of transfer of the substrate 10. However, it is obviously possible to perform a treatment by rotatably driving the treating drums 12 in the opposite direction to the direction of transfer of the substrate 10.

Alternatively, in this embodiment, when the amount of the treating solution 30 to overflow from the retention part on the outer circumferential surface of each treating drum 12 is large, the space between the outer sides of the dam plates 20 is closed with a shield plate (portion A of FIG. 3), which can prevent the treating solution 30 from flowing out from over the outer circumferential surfaces of the treating drums 12.

Incidentally, when the substrate 10 is treated using the dam plates 20, there is a concern about the following. Upon passage of the substrate 10 through the site at which the treating drums 12 are disposed, a passage space equivalent to the thickness of the substrate 10 is created between the outer circumferential surfaces of the treating drums 12, or between the outer circumferential surfaces of the treating drum 12 and the presser roller 16 opposing thereto. This causes the treating solution 30 to leak from the retention part. However, the thickness of the substrate 10 is generally by far smaller than the diameter of the treating drum 12. For this reason, there is almost no effect by the amount of the retained treating solution 30 to be reduced due to flow out of the treating solution 30 upon passage of the substrate 10. Whereas, when the treating surface of the treating drum 12 is composed of elastic material, for example, polishing cloth, the treating drum 12 itself has compressibility. Accordingly, upon passage of the substrate 10, the outer circumferential surface of the treating drum 12 comes in contact with the outer circumferential surface of the opposing treating drum 12 or presser roller 16, so that the space equivalent to the thickness of the substrate 10 is closed. This prevents the treating solution 30 from flowing out from the retention part.

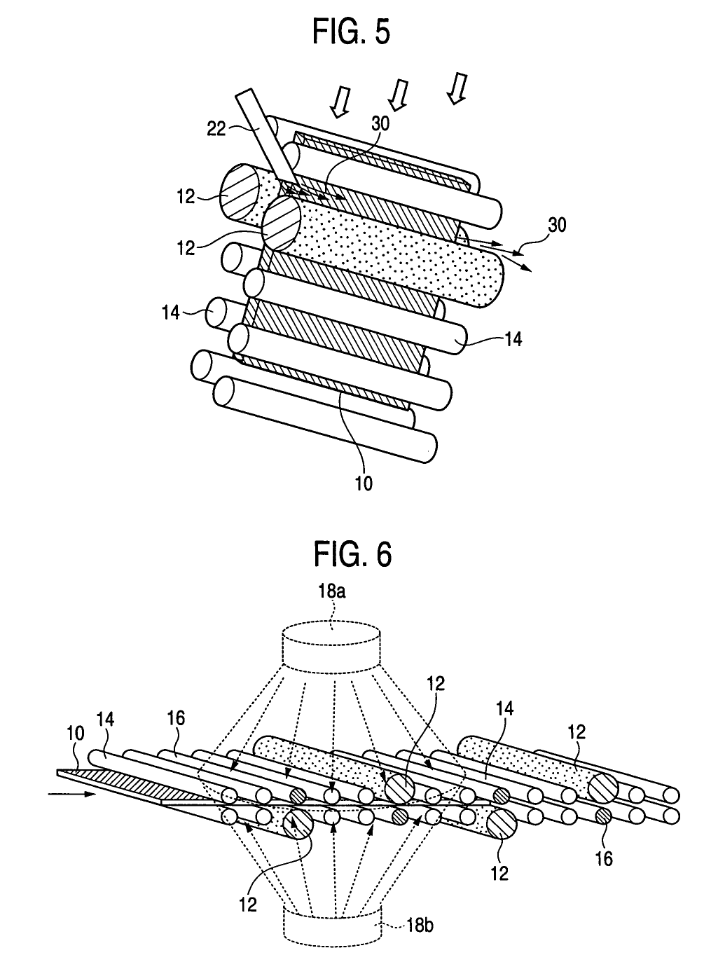

FIG. 5 shows an exemplary, non-limiting configuration of a third embodiment of the substrate treating apparatus. The treating apparatus of this embodiment is characterized in that it is configured such that the axes of the treating drums 12 and the feed rollers 14 are tilted obliquely with respect to the horizontal direction, and in that the direction of transfer of the substrate 10 is tilted obliquely with respect to the vertical direction. Incidentally, as with the foregoing embodiments, the apparatus is configured such that the substrate plane of the substrate 10 is set along the vertical direction, the treating drums 12 are respectively disposed on the opposite sides of the substrate 10, and the feed rollers 14 interpose the substrate 10 by pressure along the direction of thickness for transfer.

In this embodiment, such a configuration is adopted that the direction of axes of the treating drums 12 is tilted with respect to the horizontal direction. As shown, the apparatus is configured such that the treating solution 30 flows through the retention region sandwiched by the substrate 10 and each treating drum 12 to treat the substrate 10.

Each feed nozzle 22 is disposed above the retention region (above the treating drum 12) formed in a tilted manner in order for the treating solution 30 to flow by the gravity toward the lower part of the retention region from the upper part of the retention region of the treating solution 30 formed in the region between which the substrate 10 and the treating drum 12 oppose to each other. Thus, such a configuration is adopted that the treating solution 30 flows along each treating drum 12 from the upper part of the retention region. The feed nozzles 22 are respectively disposed for the treating drums 12 disposed on the opposite sides of the substrate 10. As a result, it is possible to feed the treating solution 30 equally to the opposite sides of the substrate 10 and to treat the substrate 10.

As for the treating apparatus of this embodiment, the treating solution 30 is fed from each feed nozzle 22 to the retention region, so that the treating solution 30 flows through the retention region. This enables a fresh treating solution 30 to invariably act on the substrate 10. As a result, it is possible to efficiently perform a surface treatment of the substrate 10. Incidentally, also in this embodiment, it is possible to perform the treatment in such a manner as to retain the treating solution 30 by using the dam plates 20 as with the second embodiment.

Incidentally, as the treating solution for treating the substrate 10, there is used, other than the treating solution for chemically etching the surface of the substrate 10, a coating solution for coating the surface of the substrate 10, a washing solution for washing the surface of the substrate 10, a polishing solution for use in polishing the surface of the substrate 10, or the like. With the substrate treating apparatus in accordance with the invention, it becomes possible to suitably treat the opposite sides of the substrate 10 by using the treating drums 12 while appropriately feeding the treating solution to the substrate 10. The substrate treating apparatus is capable of continuously transferring and treating the substrate 10, and is capable of treating the opposite sides of the substrate 10 equally in one step. For this reason, it can be preferably utilized as the treating apparatus of a substrate such as a printed circuit substrate.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A substrate treating apparatus for feeding a treating solution to a substrate while transferring the substrate, and treating surfaces of the substrate with the treating solution, the apparatus comprising:
a transfer unit for transferring the substrate;
treating drums respectively disposed on opposite surface sides of the substrate with each outer circumferential surface being in sliding contact with a surface of the substrate; and
feed units respectively disposed on opposite sides of a direction of transfer of the substrate, for feeding the treating solution to the substrate,
wherein the transfer unit is disposed so as to transfer the substrate with a substrate plane being vertically oriented.

2. The substrate treating apparatus according to claim 1, wherein the transfer unit is disposed so as to set the direction of transfer of the substrate along a direction obliquely tilted with respect to a vertical direction,
the treating drums are disposed at positions such that a direction of each axis is orthogonal to the direction of transfer of the substrate, and
the feed units are disposed such that the treating solution is fed from an upper part side of each treating drum toward the substrate, and such that the treating solution flows toward a lower part side of each treating drum along the treating drum.

3. The substrate treating apparatus according to claim 1, wherein the transfer unit is disposed such that the direction of transfer of the substrate is along a vertical direction,
the treating drums are disposed with a direction of each axis being horizontally positioned, and
the feed units are spray units for injecting the treating solution in a spray toward the substrate.

4. The substrate treating apparatus according to claim 1, further comprising:
at least one dam plate disposed on an end face side of the substrate and the treating drum, for preventing the treating solution from flowing out from an end face side of a retention region, the retention region being a region formed between the substrate and each treating drum for retaining the treating solution.

5. The substrate treating apparatus according to claim 1, wherein the transfer unit is disposed such that the direction of transfer of the substrate is along a vertical direction,
the treating drums are disposed with a direction of each axis being horizontally positioned, and
the feed units are feed nozzles each for feeding the treating solution to a retention region in an injecting manner, the retention region being a region formed between the substrate and each treating drum for retaining the treating solution.

6. The substrate treating apparatus according to claim 2, further comprising:
at least one dam plate disposed on an end face side of the substrate and the treating drum, for preventing the treating solution from flowing out from an end face side of a retention region, the retention region being a region formed between the substrate and each treating drum for retaining the treating solution.

7. A substrate treating method, comprising:
transferring a substrate with a substrate plane being vertically oriented;
feeding a treating solution to the substrate from opposite sides of a direction of transfer of the substrate; and
treating surfaces of the substrate with the treating solution.

8. The substrate treating method according to claim 7, wherein the transfer of the substrate includes transferring the substrate so as to set the direction of transfer of the substrate along a direction obliquely tilted with respect to a vertical direction,
the treatment of the substrate includes treating the surfaces of the substrate by treating drums respectively disposed on opposite surface sides of the substrate with each outer circumferential surface being in sliding contact with the surface of the substrate, the treating drums being disposed at positions such that a direction of each axis is orthogonal to the direction of transfer of the substrate, and
the feed of the treating solution includes feeding the treating solution from an upper part side of each treating drum toward the substrate, and such that the treating solution flows toward a lower part side of each treating drum along the treating drum.

9. The substrate treating method according to claim 7, wherein the transfer of the substrate includes transferring the substrate such that the direction of transfer of the substrate is along a vertical direction, and
the feed of the treating solution includes injecting the treating solution in a spray toward the substrate.

10. The substrate treating method according to claim 7, wherein the transfer of the substrate includes transferring the substrate such that the direction of transfer of the substrate is along a vertical direction,
the treatment of the substrate includes treating the surfaces of the substrate by treating drums respectively disposed on opposite surface sides of the substrate with each outer circumferential surface being in sliding contact with the surface of the substrate, and
the feed of the treating solution includes feeding the treating solution to a retention region in an injecting manner, the retention region being a region formed between the substrate and each treating drum for retaining the treating solution.
